(19) United States
(12) Patent Application Publication
(10) Pub. No.: US 2008/0175613 A1
(43) Pub. Date: Jul. 24, 2008

(54) FIXING APPARATUS

(76) Inventors: Shougo Fukai, Tokyo (JP); Atsushi Ogane, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/855,895

(22) Filed: Sep. 14, 2007

(30) Foreign Application Priority Data
Sep. 19, 2006 (JP) JP2006-252412
May 7, 2007 (JP) JP2007-122146

(51) Int. Cl. G03G 15/20

(52) U.S. Cl. 399/67

(57) ABSTRACT

A fixing apparatus comprising: a heating member; a belt that comes in contact with the heating member to form a nip portion; a pressing member that presses the belt against the heating member, wherein a sheet carrying a toner image is interposed at the nip portion formed by the heating member and the belt and fixed; a sliding member that stands between the belt and the pressing member to cause the belt to slide; and a controller to control so that a position of the sliding member is changed in a direction of rotation of the belt.

This application is based on Japanese Patent Application Nos. 2006-252412 filed on Sep. 19, 2006 and 2007-122146 filed on May 7, 2007 which are incorporated hereinto by reference.

### BACKGROUND OF THE INVENTION

The present invention relates to a fixing apparatus, and in particular, to a fixing apparatus that constitutes an image forming apparatus of an electrophotographic system.

In the image forming apparatus of an electrophotographic system, it is common to fix a toner image on a sheet by heating and fusing a toner image on the sheet.

From a point of view of energy conservation, a fixing apparatus having a short warm-up time is demanded, and in a high speed color image forming apparatus, a fixing apparatus capable of fixing a color toner image with a massive quantity of toner, while conveying a sheet at high speed, is demanded.

In a belt-type fixing apparatus employing a belt for a heating member or for a pressure applying member that presses a sheet against the heating member, a warm-up time can be made short because heat capacity of the belt is smaller than that of a heating roller, and an amount of heat for heating toner can be made large without increasing a power of a heater that applies heat to toner, because a nip portion having a large width is formed between the belt and the other side that comes in contact with the belt.

As stated above, the belt-type fixing apparatus can be regarded as an excellent fixing apparatus having the necessary conditions for energy conservation and for speeding up.

A typical belt-type fixing apparatus is of the structure wherein the belt is pressed by a pressing member representing a stationary member to come in pressure contact with a heating member, and in the belt-type fixing apparatus of this kind, there still remain the problems caused by sliding, including the problem of wear and abrasion of the belt caused by sliding.

In Unexamined Japanese Patent Application Publication No. 2005-321462, frictional resistance between a belt and a sliding member is lowered by setting the coefficient of extension for tensile load of the sliding member at 200° C. to be not more than a specific value, by causing the sliding member to stand between the belt and a pressing member that presses the belt against the other side.

In Unexamined Japanese Patent Application Publication No. 2005-84225, the frictional resistance is lowered by causing a lubricant made of denatured fluorine oil to stand between the belt and a pressing member on which the belt sides.

In Unexamined Japanese Patent Application Publication No. 2005-331574, there is relieved excessive pressure on a nip portion that is caused when strong pressure is applied locally on a pressing member, by supporting a pressing member that presses a heating member with an elastic sheet.

In the belt-type fixing apparatus wherein a belt is pressed by a pressing member to come in pressure contact with a heating member, the belt slides on a sliding pressing member under the state of pressure contact. Therefore, when the belt slides, a friction is caused, and sliding abilities are lowered when operations are conducted for a long time, or sliding abilities are lowered when the belt is scratched, thus, a sheet is not conveyed smoothly, resulting in occurrence of creases of the sheet and of displacement of images.

An improvement of a material of a sliding member and an improvement of a lubricant as in Unexamined Japanese Patent Application Publication No. 2005-321462 or in Unexamined Japanese Patent Application Publication No. 2005-84225 are limited, and it is not avoidable that a life of a belt is shortened and a cycle of belt replacement is shortened.

Further, if specific materials are used for a sliding member and for a lubricant as in Unexamined Japanese Patent. Application Publication Nos. 2005-321462 and 2005-84225, there is a problem of a cost increase.

A technology disclosed in Unexamined Japanese Patent Application Publication Nos. 2005-331574 is not sufficient for prevention of premature deterioration of the sliding member.

### SUMMARY OF THE INVENTION

According to one embodiment of the present invention, a fixing apparatus is provided with a heating member, a belt that comes in contact with the heating member to form a nip portion, a pressing member that presses the belt against the heating member and a sliding member that stands between the belt and the pressing member to cause the belt to slide, to interpose a sheet carrying a toner image between the heating member and a nip portion formed by the belt, for fixing wherein there is provided a controller to control so that a position of the sliding member may be changed in the direction of rotation of the belt is provided.

### BRIEF DESCRIPTION OF THE DRAWINGS

FIG. 1 is a diagram showing an overall image forming apparatus equipped with a fixing apparatus relating to an embodiment of the invention.

FIG. 2 is a cross-sectional view of a fixing apparatus relating to the first embodiment of the invention.

FIG. 3 is a cross-sectional view of a fixing apparatus that is one relating to the second embodiment of the invention, and is in fixing processing.

FIG. 4 is a cross-sectional view of a fixing apparatus that is one relating to the second embodiment of the invention, and is in the state of position change of the sliding member.

FIG. 5 is a cross-sectional view of a fixing apparatus that is one relating to the third embodiment of the invention, and is in fixing processing.

FIG. 6 is a cross-sectional view of a fixing apparatus that is one relating to the third embodiment of the invention, and is in the state of position change of the sliding member.

FIG. 7 is a side view of a pressure applying unit.

FIG. 8 is a hardware structural diagram of a control system in Embodiment 1.

FIG. 9 is a hardware structural diagram of a control system in Embodiment 2.

### DETAILED DESCRIPTION OF THE PREFERRED EMBODIMENT

The invention will be explained as follows based on the illustrated embodiment, to which, however the invention is not limited.

### [Image Forming Apparatus]

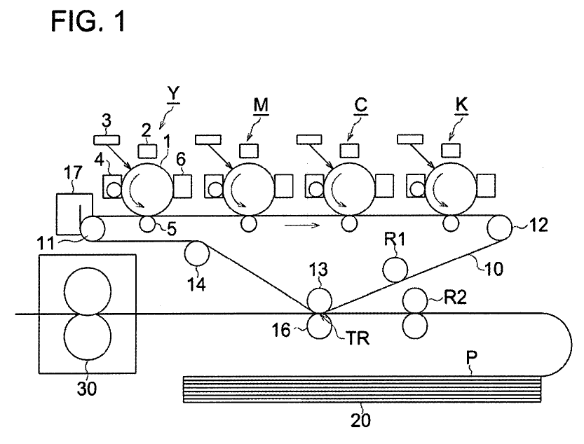

FIG. 1 is a diagram showing the overall structure of an image forming apparatus having therein a fixing apparatus relating to an embodiment of the invention.

Image forming section Y that forms a yellow toner image, image forming section M that forms a magenta toner image, image forming section C that forms a cyan toner image, and image forming section K that forms a black toner image are arranged to face intermediate transfer member 10 of an endless-belt shape.

On the lower part, sheet-housing section 20 is arranged, and sheet P housed in the sheet-housing section 20 is conveyed one by one to pass through fixing apparatus 30, after transfer apparatus 16 passes through transfer position TR to touch intermediate transfer member 10, and a toner image on sheet P is fixed.

R2 represents a registration roller representing a conveyance device that conveys sheet P in synchronizing with image forming in each of Y, M, C and K image forming sections.

Intermediate transfer member 10 representing an image carrier is entrained about plural rollers 11-14 and about tension roller R1, to move cyclically as shown with an arrow. The intermediate transfer member 10 is supported by rollers 11 and 12 horizontally on a substantial basis, and it travels through a transfer position where primary transfer is carried out.

Roller 13 constitutes a backup roller that faces transfer apparatus 16, and is grounded.

The transfer apparatus 16 has a transfer roller, and on the transfer roller, there is impressed the transfer voltage that is for transferring a color toner image formed on the intermediate transfer member 10 onto a sheet.

Tension R1 is urged by a spring to be in pressure contact with the intermediate transfer member 10 at about the halfway point between roller 12 that is supporting the intermediate transfer member 10 horizontally and the transfer apparatus 16, to give the constant tension to the intermediate transfer member 10.

The numeral 17 represents a cleaning apparatus that cleans the intermediate transfer member 10 after transferring.

The numeral 30 represents a fixing apparatus that fixes a color toner image on sheet P.

Each of image forming sections Y, M, C and K has drum-shaped photoreceptor 1, charging unit 2, exposure unit 3, developing unit 4, transfer unit 5 that conducts primary transfer and cleaning unit 6, and an electrostatic latent image is formed on the photoreceptor through charging and exposure for photoreceptor 1, then, the electrostatic latent image is developed by the developing unit 4 to form a monochromatic toner image on the photoreceptor 1, and primary transfer is carried out by the transfer unit 5 to transfer the monochromatic toner image formed on the photoreceptor 1 onto the intermediate transfer member 10. Incidentally, in the drawing, although the parts constituting the image forming section are given the symbols only for the image forming section Y, other image forming sections M, C and K have the same structure as that for the image forming section Y, and a monochromatic toner image is formed on the photoreceptor 1 through the aforesaid process in each of them.

A monochromatic toner image formed by each of the image forming sections Y, M, C and K is transferred by transfer apparatus 5 onto the intermediate transfer member, and the image forming in each of the image forming sections Y, M, C and K is conducted so that monochromatic toner images are superposed on the intermediate transfer member 10 to form color toner, thus, a full color toner image is formed on the intermediate transfer member 10.

In the image forming process, photoreceptor 1 and intermediate transfer member 10 operate as shown by arrows, whereby, a monochromatic toner image is formed in each of the image forming sections Y, M, C and K, and monochromatic toner images thus formed are transferred onto the intermediate transfer member 10, thus a color toner image is formed on the intermediate transfer member 10.

The color toner image on the intermediate transfer member 10 is transferred on sheet P by transfer apparatus 16.

The sheet P carrying the color toner image passes through fixing apparatus 30 where the color toner image is fixed on the sheet P.

### Embodiment 1

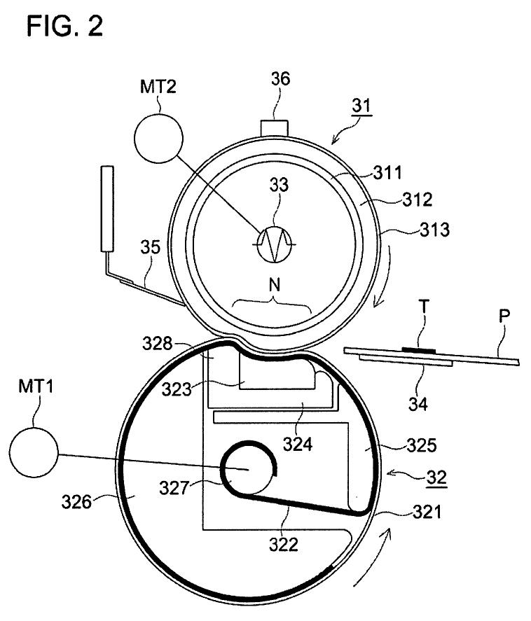

FIG. 2 is a cross-sectional view showing the structure of fixing apparatus 30 relating to Embodiment 1 of the invention.

The numeral 31 represents a heating roller representing a heating member wherein heat-resisting elastic layer 312 composed of silicone rubber is arranged on base body 311 composed of a metal pipe, and releasing surface layer 313 such as FPA (tetrafluoroethylene/perfluoroalkoxyethylene copolymer) is constructed on the elastic layer 312.

The numeral 32 represents a pressure applying unit that comes in pressure contact with heating roller 31, and it has belt 321 representing a pressure applying member, sliding member 322, pressing member 323, supporting member 324, belt guide members 325 and 326 and separating member 328.

The numeral 33 represents a heater that is a heat source for fixing, 34 represents a guide that guides sheet P to fixing apparatus 30, 35 represents a separation claw and 36 represents a temperature sensor that detects a surface temperature of heating roller 31.

Belt 321 is an endless belt which is made of heat heat-resisting resin such as PI (polyimide), PA (polyamide) and PIA (polyamideimide), and layers of fluorocarbon resin such as PFA or PTFE (polytetrafluoroethylene) may also be formed on both sides of the belt 321.

The sliding member 322 is made of glass wool wherein fluorocarbon resin such as PTFE is coated and sliding abilities are enhanced. The sliding member 322 contains heat-resisting lubricant to lower the friction resistance between the belt 321 and the sliding member 322.

The numeral 323 represents a pressing member that presses the belt 321 against heating roller 31, and it is composed of a heat-resisting elastic body such as silicone rubber or fluorocarbon rubber to press the belt 321 against the heating roller 31.

The supporting member 324 that supports the pressing member 323 is urged by a spring (not shown) to press the belt 321 against the heating roller 31. The supporting member 324 supports the pressing member 323, and supports the separating member 328 forming an apex in the vicinity of an outlet of nip portion N formed by the heating roller 31 and the belt 321.

An apex of the separating member 328 constituting a pressing member is formed to have a radius of curvature of about 0.3-4 mm.

Owing to the form of the apex of this kind of the separating member 328, elastic layer 312 of the heating roller 31 is compressed, and belt 321 is curved so that sheet P may be separated from heating roller 31 at the position where the belt 321 is separated from the heating roller 31.

Owing to the actions of this kind of the separating member 328, sheet P is separated from heating roller 31 when the sheet P slips out of the nip portion N.

Supporting member 324 including the separating member 328 is composed of rigid bodies such as PPS (polyphenylene sulfide), PI, PA, iron, aluminum and SUS.

Belt guide members 325 and 326 are made of heat-resisting resins PPS and PFA having low thermal conductivity, and they form a guide surface which is substantially cylindrical. Sliding member 322 is fixed on shaft 327, then is stretched over and in contact with the outer circumference of belt guide member 325, the pressing member 323, the separating member 328 and the belt guide member 326, and comes in contact with the inner circumference of the belt 321.

FIG. 8 is a hardware structural diagram of a control system in Embodiment 1.

Controller 40 controls second drive section (MT2), and drives heating roller 31. The controller 40 controls first drive section (MT1), and changes a position of sliding member 322 by winding sliding member 322 around the shaft 327.

A change of the position of the sliding member 322 in this case means that the sliding member 322 moves along the belt 321.

The sliding member 322 has a function to smooth the sliding of the belt 321, and the sliding of the belt 321 at the position of the separating member 328 where the pressing force is highest is smoothed.

Therefore, the change of the position of the sliding member 322 means that at least a part of the portion where the sliding member 322 interposes between the belt 321 and the separating member 328 is replaced by other portions, in the pressing position by the separating member 328.

Further, controller 40 controls pressure releasing mechanism 37 that releases pressure contact between heating roller 31 and pressure applying unit 32, and moves the pressure applying unit 32.

In the fixing process, the heating roller 31 is driven by motor MT2 representing the second drive portion to rotate in the direction of an arrow, and belt 321 is driven by the heating roller 31 to rotate.

Sheet P carrying toner image T yet to be fixed is introduced to nip portion N, and when it passes through the nip portion N, toner image T is heated and fused to be fixed on the sheet P.

When slipping out the nip portion N, the sheet P is introduced downward by the separating member 328 to be separated from heating roller 31 as explained above, and separation claw 35 assists recording sheet P which tends to wind itself round the heating roller 31 to be separated.

When the sliding member 322 is worn away after operations for a long time, pressure applying unit 32 is moved downward by the control of controller 40, and after releasing pressure contact between heating roller 31 and belt 321 by separating member 328, if the sliding member 322 is taken up around shaft 327, positions of the sliding member 322 located over the pressing member 32 and located over the separating member 328 are changed.

With respect to the change of the position of the sliding member 322, at least a part of the portion pressed by the separating member 328 of the sliding member 322 has only to be renewed.

This change of the position is made by driving the shaft 327 to rotate by motor MT1 through the control by controller 40.

Though the sliding member 322 is replaced automatically by operating motor MT1 under the control of controller 40 at each printing for a predetermined number of sheets, it is also possible to renew the sliding member 322 when it is worn away, by operations of an operator. Or, a position of the sliding member 322 can be changed in the case of the maintenance conducted by a service engineer.

The sliding member 322 is pressed against heating member 31 by separating member 328 with an especially strong pressure. Therefore, a portion of the sliding member 322 positioned over the separating member 328 tends to be worn away. However, by setting a portion yet to be pressed to the position to be pressed by the separating member 328 in the case of the aforesaid change of the position, sliding abilities between the belt 321 and the sliding member 322 can be maintained properly on the portion over the separating member 328. Meanwhile, with respect to the change of the position of the sliding member 322 of this kind, a portion to be pressed by the separating member 328 may also be replaced through plural changes of the portion to be pressed, without being replaced by a single change of the position to be pressed by the separating member 328.

In the change of the position of the sliding member 322, the sliding member 322 is moved for a necessary distance by taking up the shaft 327, wherein it is preferable to loosen the sliding member 322 by rotating the shaft 327 in the direction opposite to the direction for taking up the shaft 327, after the taking up. Due to this, the stress caused between the belt 321 and the sliding member 322 by the taking up of the shaft is relaxed, and sliding of the belt 321 is smoothed.

### Embodiment 2

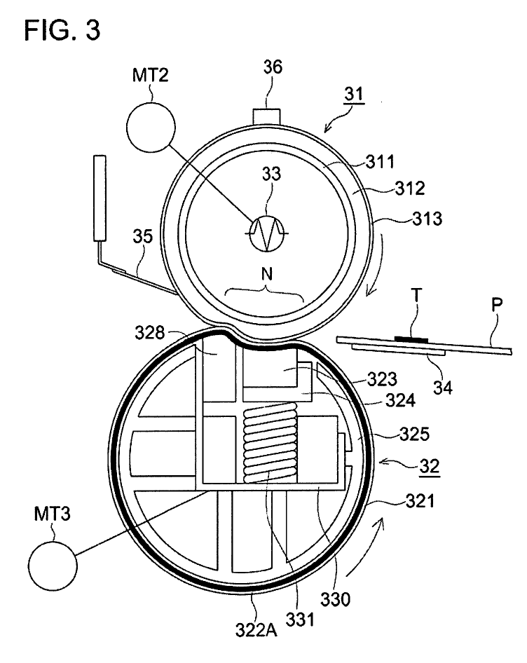

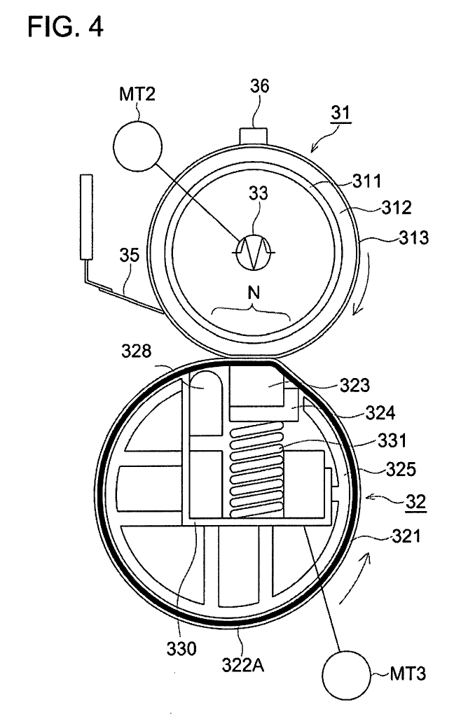

Each of FIG. 3 and FIG. 4 shows fixing apparatus 30 relating to the second embodiment of the invention, and FIG. 3 shows fixing apparatus 30 in the fixing process and FIG. 4 shows fixing apparatus 30 whose sliding member is the state of position changes.

Parts which are the same as those in FIG. 2 are given the same symbols.

Sliding member 322A is composed of an endless belt.

Separating member 328 and belt guide member 325 are fixed on substrate frame 330.

On the substrate frame 330, there is further fixed a lower end of coil spring 331 of a compression type, and an upper end of the coil spring 331 supports supporting member 324 that supports pressing member 323.

Therefore, the belt 321 and the sliding member 322A are pressed against heating roller 31 by elasticity of pressing member 323 and that of the coil spring 331.

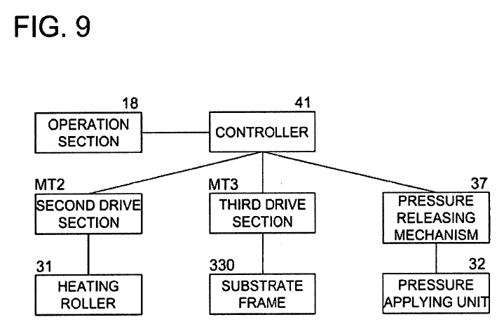

FIG. 9 is a hardware structural diagram of a control system in Embodiment 2.

Controller 41 and a second drive section (MT2) are controlled to drive heating roller 31. Further, the controller 41 controls a third drive section (MT3) to move substrate frame 330, and changes a position of the sliding member 322A.

Further, the controller 41 controls pressure releasing mechanism 37 that conducts pressure contact between heating roller 31 and pressure applying unit 32 and conducts releasing of the pressure contact, and it moves the pressure applying unit 32.

In the fixing apparatus shown in FIG. 3, a nip portion is formed between belt 321 pressed by pressing member 323 and heating roller 31, in the same way as in the foregoing, and a toner image on sheet P that passes through the nip portion N is fixed.

When renewing the sliding member 322A, pressure applying unit 32 is driven by motor MT3 to move downward as shown by FIG. 4. This movement is conducted by moving the substrate frame 330 by motor MT3.

With a descent of the substrate frame 330, separating member 328 fixed on the substrate frame 330 moves downward, and belt 321 positioned above the separating member 328 and the sliding member 322A leave the heating roller 31.

With a descent of the substrate frame 330, coil spring 331 falls. However, the portions of the belt 321 and of the sliding member 322A both being in touch with heating roller 31 do not fall as shown in FIG. 4, because coil spring 331 extends, whereby, the state of pressing of the belt 321 can be maintained.

Motor MT2 rotates under the condition shown in FIG. 4.

Under the condition shown in FIG. 4, sliding member 322A and belt 321 are in the state where they can move easily, because the separating member 328 is away from heating member 331.

With a rotation of heating member 31, belt 321 that is in contact with heating roller 31 is moved, and sliding member 322A that is in contact with belt 321 is moved.

Motor MT2 moves a portion of sliding member 322A that is pressed by separating member 328 strongly, and positions a new portion to an upper part of separating member 328 to stop it.

Owing to this, a position of the sliding member 322A is changed.

Replacement of the position of the sliding member 322A is conducted by the controller for each fixing of prescribed number of sheets, for example, for each fixing of 1-200,000 sheets.

Change from the state in FIG. 3 to the state in FIG. 4 for the fixing apparatus, namely, releasing of pressure contact between heating roller 31 and belt 321 is conducted after each completion of fixing, namely, after completion of an image forming job.

In the releasing of pressure contact conducted after completion of the fixing process, renewal of the sliding member by rotation of heating roller 31 is not carried out. Renewal of sliding member 322A is conducted by rotating heating roller 31 for each fixing of prescribed number of sheets as stated above.

In the meantime, it is also possible to change the position of sliding member 322A by rotating heating roller 31 after completion of each fixing process. In the position change of this kind, the whole portions of the sliding member 322A are pressed uniformly by separating member 328, and are deteriorated evenly, resulting in achievement of a purpose of long life.

In the present embodiment, a position of the sliding member can be changed by the use of the second drive section for fixing, without providing a driving section exclusively for the position change for sliding member 322A. Therefore, it is possible to control a cost increase caused by providing a position change mechanism for the sliding member.

### Embodiment 3

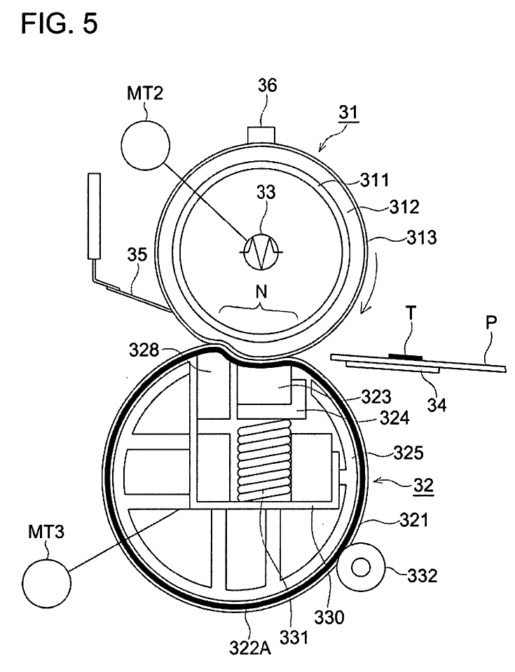

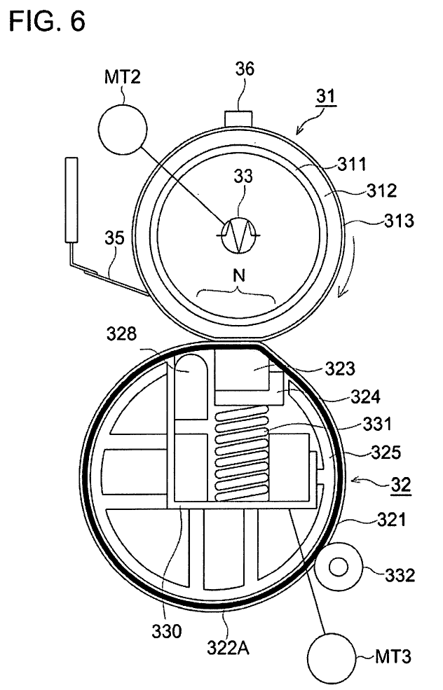

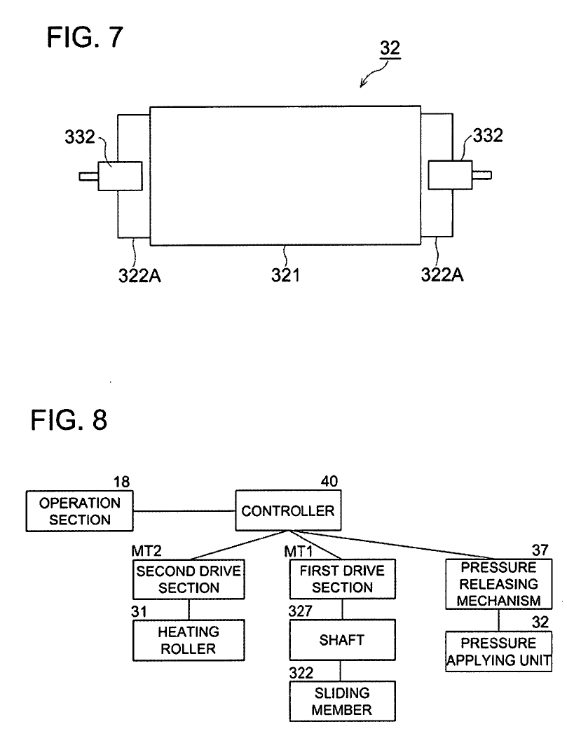

Each of FIGS. 5-7 shows fixing apparatus 30 relating to Embodiment 3 of the present invention, and FIG. 5 shows the fixing apparatus 30 in fixing processing, FIG. 6 shows the fixing apparatus 30 that is in the state of changing a position of a sliding member and FIG. 7 is a side view of pressure applying unit 32.

Parts which are the same as those in FIGS. 2-4 are given the same symbols.

Frictional member 332 is in contact with sliding member 322A, and the frictional member 332 is made of rubber and is fixed on a frame of fixing apparatus 30.

A width of the sliding member 322A is formed to be greater than a width of belt 321. As shown in FIG. 7, sliding member 322A is exposed at each of both ends of pressure applying unit 32 (both ends of a sheet in the lateral direction for conveyance).

The frictional member 332 comes in contact with sliding member 332A at each of both ends.

In operations of the pressure applying unit 32 to move downward from the state of fixing in FIG. 5, namely, from the state of pressure contact and thereby to enter the pressure contact releasing state in FIG. 6, a force caused by the frictional member 332 does not operate on the belt 321. However, since the sliding member 322A is in contact with the frictional member 332, it receives, from the frictional member 332, a force for urging to move upward relatively to the belt 321, guide member 325 and separating member 328, at the location where the sliding member is in contact with the frictional member 332, when the sliding member moves, thus, the sliding member 322A moves relatively to the separating member 328, and a position of the portion where the sliding member 322A was in contact with the separating member 328 is moved, and a position of the sliding member is changed.

Since a change of the position of the sliding member is made for each releasing of pressure contact, the whole portions of the sliding member 322A composed of an endless belt are pressed uniformly by separating member 328, and are deteriorated evenly, resulting in achievement of a long life of the sliding member 322A.

In addition, since a position of the sliding member can be changed, without providing a drive section for the position change, it is possible to control a cost increase caused by providing a position change mechanism for the sliding member.

Incidentally, it is also possible to renew a position of sliding member 322A for each fixing for the prescribed number of sheets, by driving frictional member 332 with a drive device such as a solenoid.

In the present invention, a sliding member is interposed between a pressing member that presses a belt against a heating member and the belt, so that the sliding member may be renewed. Therefore, it is possible to keep sliding abilities between the belt and the sliding member to be in excellent conditions constantly, and to conduct excellent fixing for a long time, thus, it is possible to realize a fixing apparatus having a long life or a long maintenance cycle.

What is claimed is:

1. A fixing apparatus comprising:
(a) a heating member;
(b) a belt that comes in contact with the heating member to form a nip portion;
(c) a pressing member that presses the belt against the heating member, wherein a sheet carrying a toner image is interposed at the nip portion formed by the heating member and the belt and fixed;
(d) a sliding member that stands between the belt and the pressing member to cause the belt to slide; and
(e) a controller to control so that a position of the sliding member is changed in a direction of rotation of the belt.

2. The fixing apparatus of claim 1, wherein the pressing member comprises a separating member which presses the belt and the sliding member against the heating member at an end portion on an outlet side of the nip portion.

3. The fixing apparatus of claim 1, wherein the separating member has an apex having a radius of curvature of 0.3 to 4 mm, and the apex presses the belt and the sliding member.

4. The fixing apparatus of claim 2, wherein the controller controls so that a position of the sliding member that are pressed by the separating member is changed.

5. The fixing apparatus of claim 1, further comprising a first drive section which winds up the sliding member, wherein the controller controls the first drive section to change the position of the sliding member in the direction of the rotation of the belt.

6. The fixing apparatus of claim 5, wherein the first drive section comprises a shaft on which one end of the sliding member is fixed, the sliding member is stretched from the shaft and over a position between the belt and the pressing member, and the position of the sliding member is changed by a rotation of the shaft.

7. The fixing apparatus of claim 6, wherein the first drive section has a motor which rotates and drives the shaft.

8. The fixing apparatus of claim 7, wherein the controller controls to change the position of the sliding member by rotating the motor in one direction and to rotate the motor in a direction opposite to the one direction after the position has been changed.

9. The fixing apparatus of claim 4, further comprising a second drive section which drives the heating member, wherein the controller releases pressure to a part of the pressing member and holds pressure to the other parts of the pressing member in a pressure contact releasing state in which pressure contact between the heating member and the pressing member is released, during which the controller changes the position of the sliding member with respect to the separating member by operating the second drive section.

10. The fixing apparatus of claim 9, wherein the controller changes the position of the sliding member with respect to the separating member by releasing pressure to the separating member, holding the pressure of the pressing member other than the separating member, and operating the second drive section.

11. The fixing apparatus of claim 4, further comprising a friction member provided in contact with the sliding member and fixed on a frame of the fixing apparatus, wherein the position of the sliding member with respect to the separating member is changed by the sliding member being prevented from moving when the pressure contact between the heating member and the pressing member is released.

12. The fixing apparatus of claim 4, wherein the controller controls to change the position of the sliding member at each fixing operation for a predetermined number of sheets.

13. The fixing apparatus of claim 4, wherein the controller controls to change the position of the sliding member when the pressure contact between the heating member and the pressing member is released, which is conducted when a fixing operation for a sheet is completed.
